(19) United States
(12) Patent Application Publication
(10) Pub. No.: US 2008/0140757 A1
(43) Pub. Date: Jun. 12, 2008

(54) Asynchronously Coordinated Distance Training System

(75) Inventors: James Sanchez, Lakewood, CA (US); Jody Liang, Chatsworth, CA (US)

Correspondence Address: PROCOPIO, CORY, HARGREAVES & SAVITCH LLP, 530 B STREET, SUITE 2100, SAN DIEGO, CA, 92101, US

(73) Assignee: COMPLIANCE COACH, INC., San Diego, CA (US)

(21) Appl. No.: 11/760,585

(22) Filed: Jun. 8, 2007

Related U.S. Application Data
(60) Provisional application No. 60/804,322, filed on Jun. 9, 2006.

(51) Int. Cl. G06F 15/16; G06F 7/00; G06F 17/30

(52) U.S. Cl. 709/201; 707/10; 707/E17.009

(57) ABSTRACT

Systems and methods for asynchronously coordinated distance training are provided that reintegrate the instructor into the distance learning process to provide students with live, real time interaction for improved effectiveness of training. The system provides the instructor with an ability to control the distance training session in a manner that allows students to interact with the training session at appropriate times and prevents students from browsing away at other times during the training session. This also improves the effectiveness of the training.

### RELATED APPLICATION

The present application claims priority to U.S. provisional patent application Ser. No. 60/804,322 filed on Jun. 9, 2006, which is incorporated herein by reference in its entirety.

### BACKGROUND

1. Field of the Invention

The present invention relates to the field of distance training.

2. Related Art

Conventional computer implemented distance training solutions suffer from a lack of real time interaction with a teacher or instructor that can provide a student with the additional information or explanations needed for full comprehension of the subject matter. These conventional systems additionally suffer from an inability to control the distance training session, which allows a student to browse away from the training session, losing focus on the course. Therefore, what is needed is a system and method that overcomes these significant problems found in the conventional systems as described above.

### SUMMARY

Accordingly, systems and methods for asynchronously coordinated distance training are provided that reintegrates an instructor into the distance learning process to provide students with live, real time interaction for improved effectiveness of training. Additionally, the system provides the instructor with an ability to control the distance training session in a manner that allows students to interact with the training session at appropriate times and prevents students from browsing away during the training session and losing focus on the training at hand, which also improves the effectiveness of the training.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a network diagram illustrating an example system level view of an asynchronously coordinated distance training system according to an embodiment of the present invention;

FIG. 2 is a block diagram illustrating an example component view of a Student Easel according to an embodiment of the present invention;

FIG. 3 is a block diagram illustrating an example content view of a Student Viewport with the Glass disabled according to an embodiment of the present invention;

FIG. 4 is a block diagram illustrating an example content view of a Student Viewport with the Glass enabled according to an embodiment of the present invention;

FIG. 5 is a block diagram illustrating an example component view of a Trainer Easel according to an embodiment of the present invention;

FIG. 6 is a block diagram illustrating an example component view of a Trainer Easel Notepad according to an embodiment of the present invention;

FIG. 7 is a flow diagram illustrating an example Location Coordination process according to an embodiment of the present invention;

FIG. 8 is a flow diagram illustrating an example Glass Control process according to an embodiment of the present invention;

FIG. 9 is a flow diagram illustrating an example End Session process according to an embodiment of the present invention;

FIG. 10 is a flow diagram illustrating an example Close Remote process according to an embodiment of the present invention; and

FIG. 11 is a block diagram illustrating an example computer system that may be used in connection with various embodiments described herein.

### DETAILED DESCRIPTION

Certain embodiments as disclosed herein provide for or asynchronously coordinated distance training that provides live, real time interaction between student and instructor for improved effectiveness of training. For example, one method as disclosed herein allows an instructor to control the distance training session to allow students to interact with the training session at appropriate times and prevent students from browsing away during the training session.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

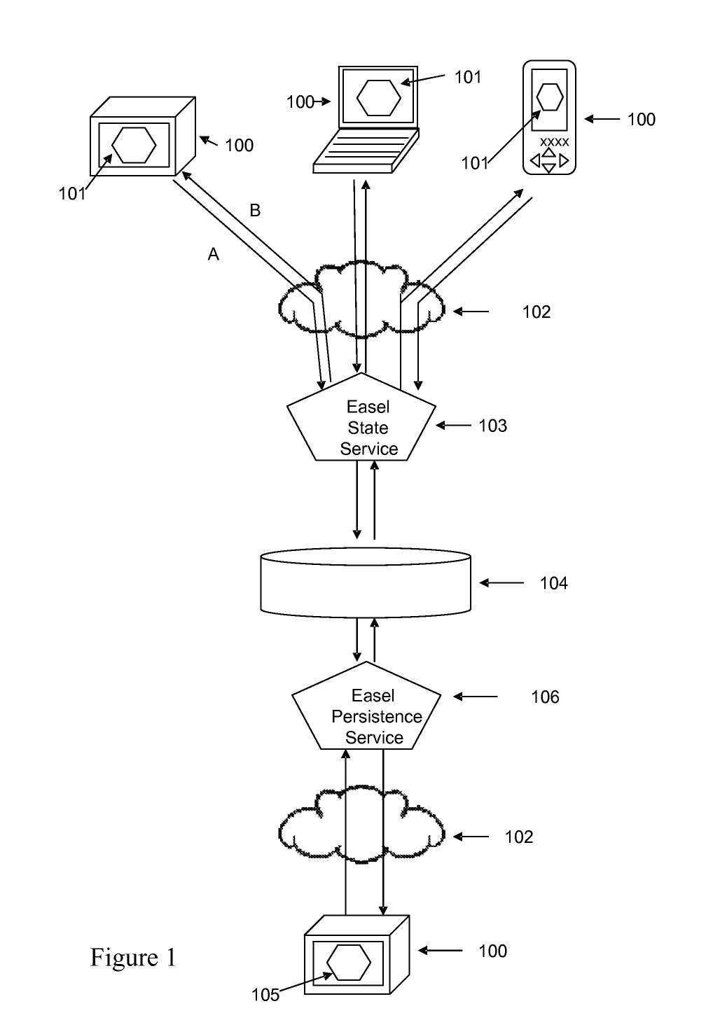

FIG. 1 is a network diagram illustrating an example system level view of an asynchronously coordinated distance training system according to an embodiment of the present invention. In the illustrated embodiment, the system includes a plurality of Remote Units 100 running the Student Easel Process 101 and connected via a Network 102 to an Easel State Service 103. Suitable Remote Units 100 include but are not limited to desktop computers, laptops, and wireless devices such as personal data devices, smart telephones, and other such devices capable of transmitting data as shown by the labeled arrow A and receiving responses shown by the labeled arrow B. The Network 102 may be any of a variety of private or public wired or wireless networks, for example the public Internet, a private intranet or extranet, or other networking implementation that allows multiple Remote Units to communicate.

The system further includes a single Remote Unit 100 running the Trainer Easel Process 105, which connects via a Network 102 to an Easel Persistence Service 106. The Easel State Service 103 and the Easel Persistence Service 105 interact with a Datastore 104 which is capable of storing data beyond its running instance of operation. The Datastore may be implemented using a Relational Database, Object Oriented Database, or file based storage; this list of implementations is understood to be exemplary and there are other implementations possible which are contemplated by the broad scope of the present invention, as will be understood by those having skill in the art. The Easel Persistence Service 106 stores data for the Trainer Easel Process 105 into the Datastore 104 as necessary. The Easel State Service 103 reads data for the Trainer Easel Process 105 from the Datastore 104 periodically to maintain data suitable for response to requests for any instance of the Trainer Easel Process 105. Criteria for the suitability of data in one embodiment is where the update time for the Easel Persistence Service 106 is shorter than or equal to the periodic request time for the Student Easel Process 101. Criteria for other embodiments may include an update per every request made by the Student Easel Process 101 to the Easel State Service 103, or a signal event by the Easel Persistence Service 106 to the Easel State Service 103. Other embodiments to determine suitability of the data are possible and this is understood to be within the scope of the invention. In addition, while FIG. 1 shows the Easel Persistence Service 106 separate from the Easel State Service 103, other embodiments may combine these two services into one service.

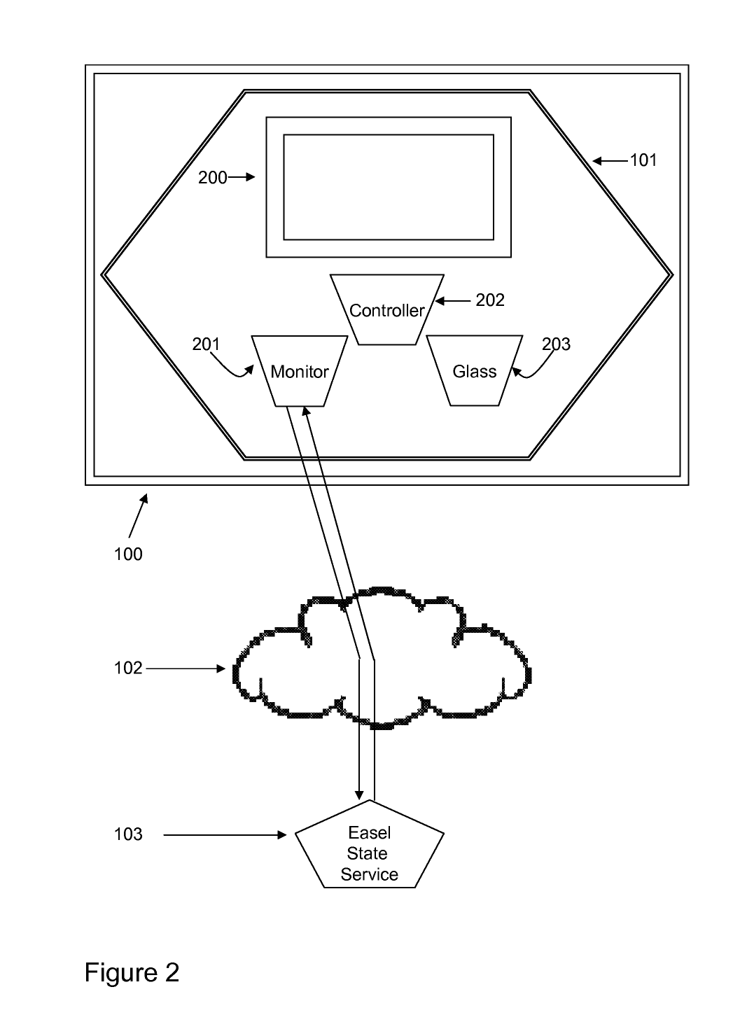

FIG. 2 is a block diagram illustrating an example component view of a Student Easel according to an embodiment of the present invention. In the illustrated embodiment, a Remote Unit 100 processes the Student Easel Process 101. The Student Easel Process 101 contains a Student Viewport 200, a Monitor Module 201, a Controller Module 202, and a Glass Module 203. In one embodiment the Monitor Module 201, periodically and asynchronously to the Student Viewport 200, requests the data of the Trainer Easel Process 105 across the Network 102 from the Easel State Service 103. The Easel State Service 103 determines if the data for the requested Trainer Easel Process 105 is suitable for response to the request, and if not, will retrieve suitable data from the Datastore 104. The Easel State Service 103 responds with requested data to the Monitor Module 201. The Monitor Module 201 reports the data to the Controller Module 202, which will decide if the Student Viewport 200 URL location needs to be changed. Based on the data provided by the Monitor Module 201 from the Easel State Service 103, the Controller Module 202 may request that the Glass Module 203 enable or disable the student interactivity in the Student Viewport 200.

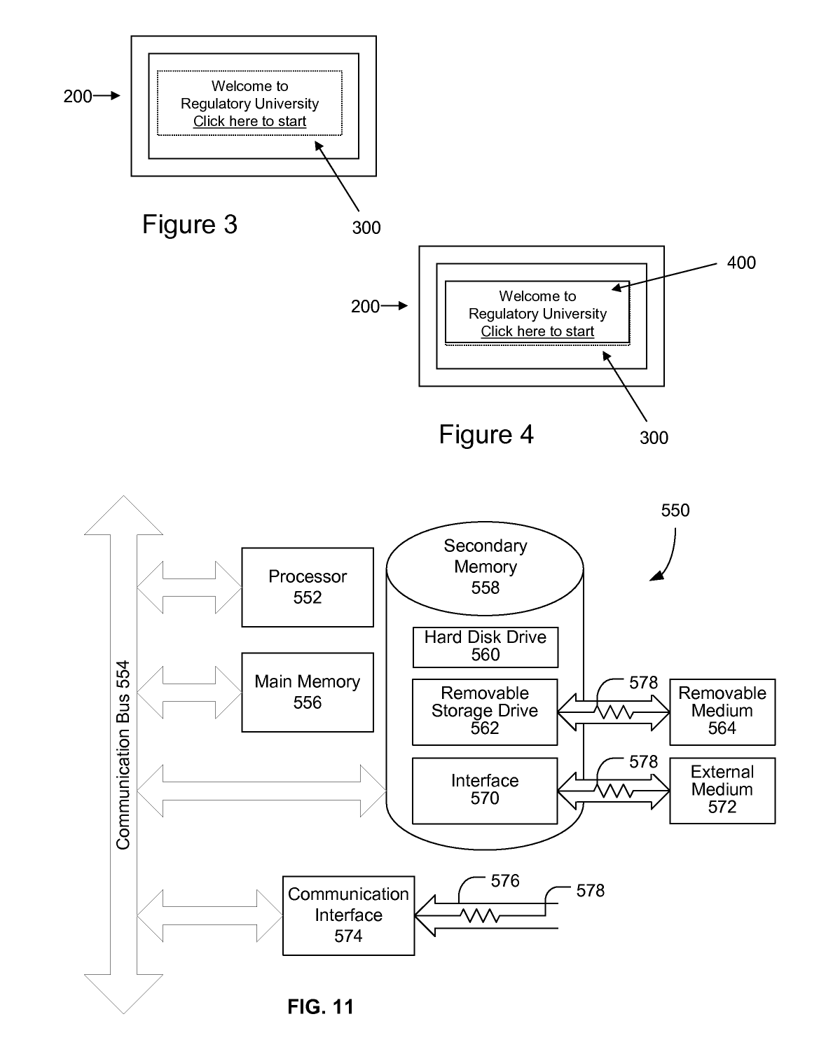

FIG. 3 is a block diagram illustrating an example content view of a Student Viewport with the Glass disabled according to an embodiment of the present invention. In the illustrated embodiment, the Student Viewport displays a Content 300. Examples of Content 300 are HTML, XHTML, XML, DHTML, Movies in Macromedia Flash, MPEG, or other text, graphics, audio, or video which may be displayed in a common Internet Browser window. With the Glass disabled, the Content 300 may be interacted with without interference.

FIG. 4 is a block diagram illustrating an example content view of a Student Viewport with the Glass enabled according to an embodiment of the present invention. In the illustrated embodiment, the Student Viewport displays Content 300. With the Glass 400 enabled, interactivity with the Content 300 is blocked by stopping the interactivity but not the display. In one embodiment, the Glass 400 may be implemented with an HTML “div” layer with transparency set to one hundred percent (100%) and be placed on top of the Content 300 thereby blocking the use of links, forms inputs, etc while the Glass 400 is enabled. The decision to enable or disable the Glass 400 is made by the Controller Module 202 as determined by the data given to the Student Easel Process 101 by the Easel State Service 103.

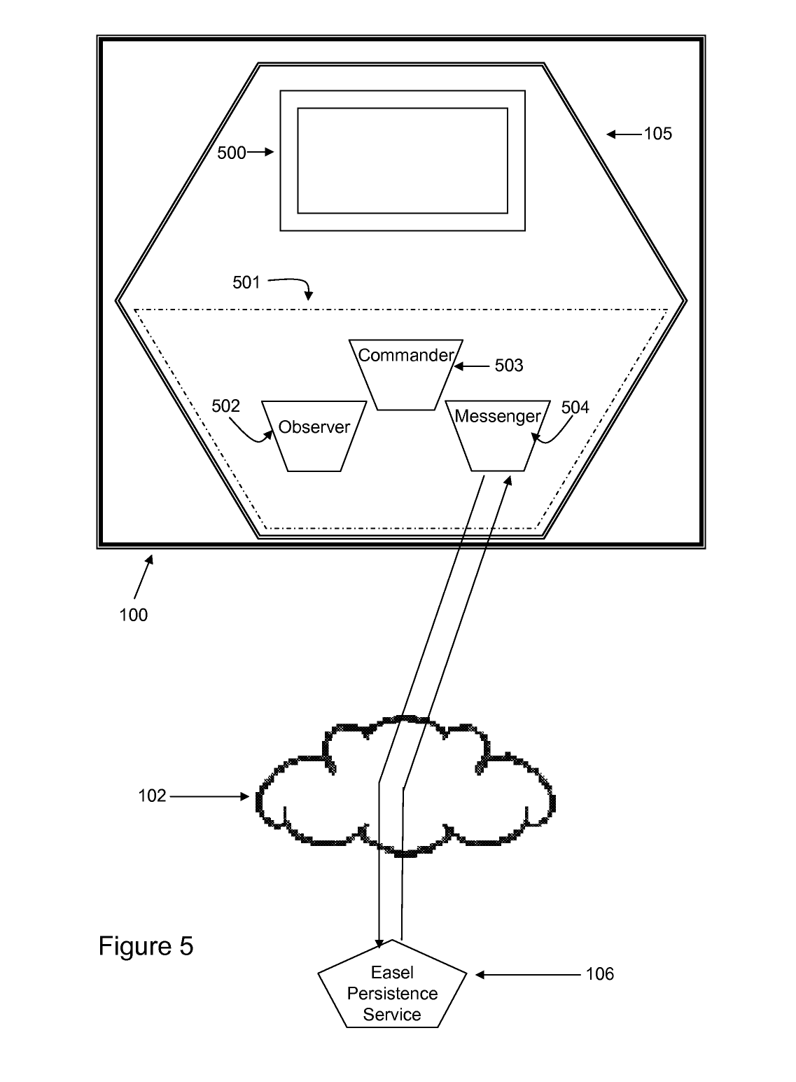

FIG. 5 is a block diagram illustrating an example component view of a Trainer Easel according to an embodiment of the present invention. In the illustrated embodiment, a Remote Unit 100 executes the Trainer Easel Process 105. The Trainer Easel Process 105 contains a Trainer Viewport 500, a Remote Control Module 501, an Observer Module 502, a Commander Module 503, and a Messenger Module 504. In one embodiment the Observer Module 502, periodically and asynchronously to the Trainer Viewport 500, calculates the current URL location of the Trainer Viewport 500, and reports this data to the Commander Module 503. The Commander Module 503 determines if the data for the Trainer Easel Process 105 has changed, and if so, will communicate the data using the Messenger Module 504. The Messenger Module 504 transmits the data across the Network 102 to the Easel Persistence Service 106. The Easel Persistence Service will store the data into the Datastore 104. The Remote Control Module 501 may also command at the Trainer's request, to enable or disable the Glass 400, or to end the session or end the remote link for the session. The Remote Control Module 501 provides these commands to the Commander Module 503 for determination of necessary updates to the data of the Trainer Easel Process 105. The Commander Module 503 uses the Messenger Module 504 to transmit the data across the Network 102 to the Easel Persistence Service 106. The location and associated commands represent one embodiment of data for the Trainer Easel Process 105 however it is not an exhaustive list of the entire set of transmittable data of the Trainer Easel Process 105 which equivalent embodiments may send.

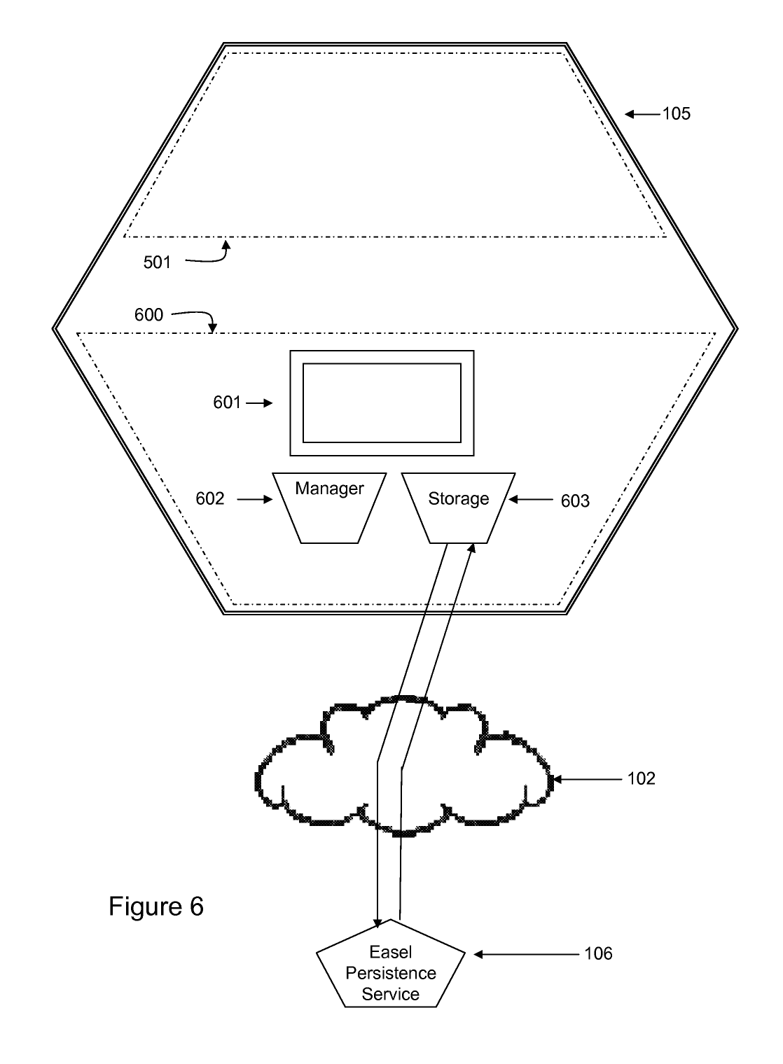

FIG. 6 is a block diagram illustrating an example component view of a Trainer Easel Notepad according to an embodiment of the present invention. In the illustrated embodiment, the Trainer Easel Process 105 further comprises a Notepad Module 600 suitable for editing and storing text notes. The Notepad Module 600 comprises an Edit Module 601, a Manager Module 602, and a Storage Module 603. The Edit Module 601 allows the Trainer to add, edit, and delete text contained as data to the module. The Manager Module 602 commands the Storage Module 603 to store the current Edit Module 601 data asynchronously to the operation of the Edit Module 601. The Storage Module 603 transmits the data of the Edit Module 601 to the Easel Persistence Service 106 across the Network 102. The Easel Persistence Service 106 stores the data into the Datastore 104.

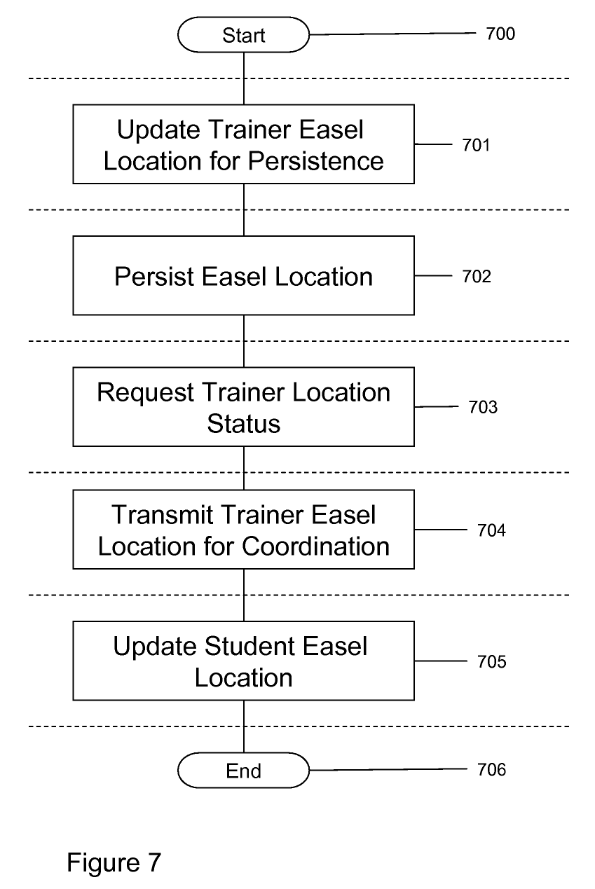

FIG. 7 is a flow diagram illustrating an example Location Coordination process according to an embodiment of the present invention. In the illustrated embodiment, the method begins at start block 700; it is understood that there are equivalent embodiments which achieve the same result of this process and are considered within the scope of the invention. The process may be started by the Trainer initiating a System Session setting the Trainer Viewport 500 to a particular URL location. Alternatively, the Trainer may follow a link or set the current Trainer Viewport 500 to a particular URL location during training. At block 701 the Observer Module 502 notifies the Commander Module 503 that the Trainer Viewport 500 URL Location has changed. The Commander Module 503 uses the Messenger Module 504 to transmit the data to the Easel Persistence Service 106 for storage. At block 702 the Easel Persistence Service 106 receives the data transmission and stores the data into the Datastore 104. At block 703 the Student Easel Process 101 periodically and asynchronously to the Student Viewport 200, requests the Trainer Easel Process location data from the Easel State Service 103 using the Monitor Module 201. At block 704 the Easel State Service 103 determines if the requested data is suitable for response, and if not updates the data from the Datastore 104. The Easel State Service 103 transmits the Trainer Easel Process 105 URL location data to the Monitor Module 201. At block 705 the Monitor Module 201 presents the URL location data for the Trainer Easel Process 105 to the Controller Module 202, which determines if the Student Viewport 200 needs to be updated. If this is the case, the Controller Module 202 sets the current URL location of the Student Viewport 200 to the same URL location of the Trainer Easel Process 105. This ends the process at end block 706.

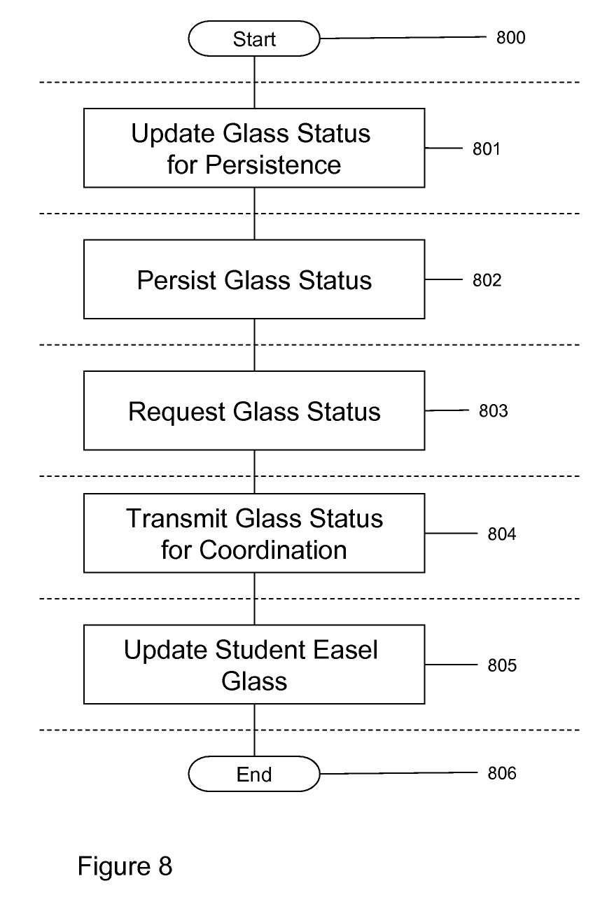

FIG. 8 is a flow diagram illustrating an example Glass Control process according to an embodiment of the present invention. In the illustrated embodiment, the method begins at start block 800; it is understood that there are equivalent embodiments which achieve the same result of this process and are considered within the scope of the invention. The process may be started by the Trainer requesting a change to the current Student Trainer Process 103 interactivity setting. At block 801 the Remote Control Module 501 notifies the Commander Module 503 that the Glass 400 status has requested to be changed. The Commander Module 503 uses the Messenger Module 504 to transmit the data to the Easel Persistence Service 106 for storage. At block 802 the Easel Persistence Service 106 receives the data transmission and stores the request data into the Datastore 104. At block 803 the Student Easel Process 101 periodically and asynchronously to the Student Viewport 200, requests the Glass 400 status data from the Easel State Service 103 using the Monitor Module 201. At block 804 the Easel State Service 103 determines if the requested data is suitable for response, and if not updates the data from the Datastore 104. The Easel State Service 103 transmits the Trainer Easel Process location data to the Monitor Module 201. At block 805 the Monitor Module 201 presents the Glass 400 status data to the Controller Module 202, which determines if the Glass 400 needs to be modified. If this is the case, the Controller Module 202 requests the Glass Module 203 to enable or disable the Glass 400 of the Student Viewport 200. This ends the process at end block 806.

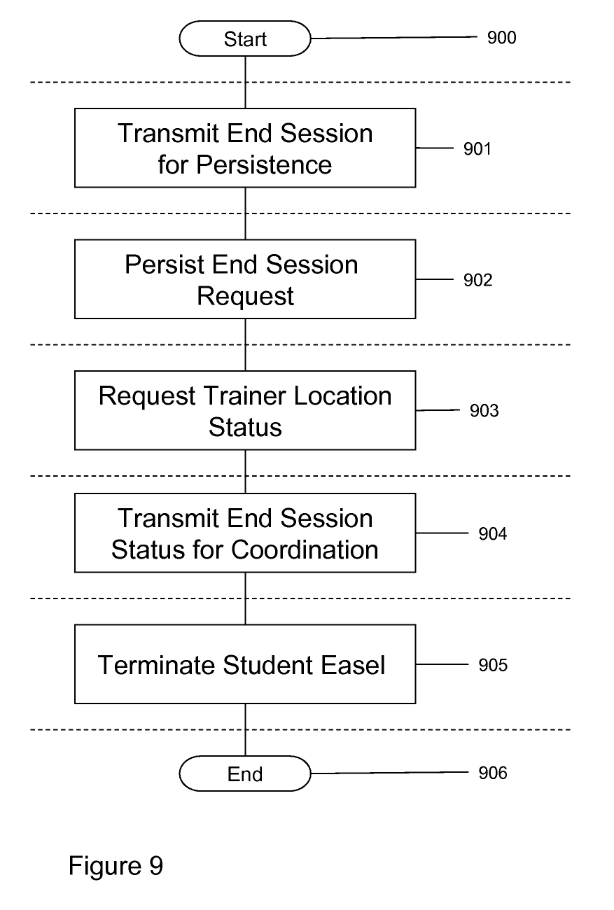

FIG. 9 is a flow diagram illustrating an example End Session process according to an embodiment of the present invention. In the illustrated embodiment, the method begins at start block 900; it is understood that there are equivalent embodiments which achieve the same result of this process and are considered within the scope of the invention. The process may be started by the Trainer requesting an end to the training session. At block 901 the Remote Control Module 501 notifies the Commander Module 503 that the session is to end. The Commander Module 503 uses the Messenger Module 504 to transmit the end session request data to the Easel Persistence Service 106 for storage. At block 902 the Easel Persistence Service 106 receives the data transmission and stores the request data into the Datastore 104. At block 903 the Student Easel Process 101 periodically and asynchronously to the Student Viewport 200, requests the Trainer Easel Process 105 URL location data from the Easel State Service 103 using the Monitor Module 201. At block 904 the Easel State Service 103 determines if the requested data is suitable for response, and if not updates the data from the Datastore 104. The Easel State Service 103 transmits the end session request data of the Trainer Easel Process 105 to the Monitor Module 201. At block 905 the Monitor Module 201 presents the end session request data to the Controller Module 202. The Controller Module 202 closes the Student Trainer Process 101 on the Remote unit 100. This ends the process at end block 906.

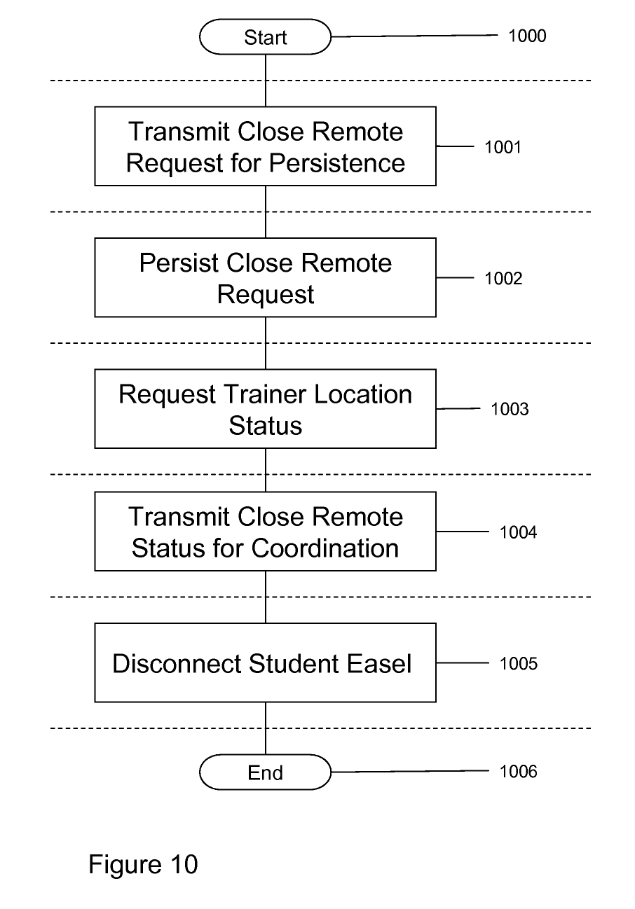

FIG. 10 is a flow diagram illustrating an example Close Remote process according to an embodiment of the present invention. In the illustrated embodiment, the method begins at start block 1000; it is understood that there are equivalent embodiments which achieve the same result of this process and are considered within the scope of the invention. The process may be started by the Trainer making a request to end remote link. At block 1001 the Remote Control Module 501 notifies the Commander Module 503 of the end remote link request. The Commander Module 503 uses the Messenger Module 504 to transmit the end remote link request data to the Easel Persistence Service 106 for storage. At block 1002 the Easel Persistence Service 106 receives the data transmission and stores the request data into the Datastore 104. At block 1003 the Student Easel Process 101 periodically and asynchronously to the Student Viewport 200, requests the URL location data for the Trainer Easel Process 105 from the Easel State Service 103 using the Monitor Module 201. At block 1004 the Easel State Service 103 determines if the requested data is suitable for response, and if not updates the data from the Datastore 104. The Easel State Service 103 transmits the end remote link request data from the Trainer Easel Process 105 to the Monitor Module 201. At block 1005 the Monitor Module 201 presents the end remote link request data to the Controller Module 202. The Controller Module 202 disables the Monitor Module 201 in the Student Trainer Process 101 on the Remote unit 100. This ends the process at end block 1006.

FIG. 11 is a block diagram illustrating an example computer system 550 that may be used in connection with various embodiments described herein. In the various embodiments described herein, for example, the computer system 550 may be used in conjunction with a remote unit, a data store, a device hosting an easel state service or easel persistent service, or a content provider such as a web server, as previously described. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well. The communication interface 574 may also provide the computer system 550 with a wireless communication capability.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. An asynchronously coordinated distance training system comprising:
a first remote unit configured to run a first process;
a datastore;
an easel persistence module communicatively coupled with the first remote unit via a network and capable of storing data from the first process in the datastore;
an easel state module capable of reading data from the datastore and providing the data to the first process; and
a second remote unit configured to run a second process, the second process configured to periodically and asynchronously request data from the first process via the network through the easel state module and is further configured to selectively enable and disable a glass module based on the data from the first process.

2. The system of claim 1 wherein the data store is a relational database, an object oriented database, or a file based storage.

3. The system of claim 1 wherein when the glass module is disabled an interaction with a viewport on the second remote unit is possible and when the glass module is enabled an interaction with a viewport on the second remote unit is not possible.

4. The system of claim 1 wherein when the glass module is enabled an interaction with a viewport on the second remote unit is not possible and a display associated with the second remote unit is possible.

5. The system of claim 1 wherein the first process periodically and asynchronously calculates a current uniform resource locator (URL) associated with a viewport on the first remote unit and reports the current URL to the easel persistence module.

6. The system of claim 1 wherein the first process is configured to send a command which enables or disables the glass module on the second remote unit.

7. The system of claim 1 further comprising a notepad module associated with the first process, the notepad module capable of storing a textual notation, the textual notation capable of being transmitted to the datastore via the easel persistence module.

8. A method for coordinated distance training comprising:
executing a first process on a first remote unit;
storing data from the first process in a datastore via a communicative coupling between the first remote unit and the datastore;
reading data from the datastore and providing the data to the first process via the communicative coupling;
executing a second process on a second remote unit, the second process including a glass module;
requesting data by the second process from the first process; and
selectively enabling or disabling the glass module in the second remote unit based on the requested data.

9. The method of claim 8 wherein the data store is a relational database, an object oriented database, or a file based storage.

10. The method of claim 8 wherein the step of selectively enabling or disabling further comprises:
disabling an interaction with a viewport on the second remote unit when the glass module is enabled; and
enabling an interaction with a viewport on the second remote unit when the glass module is disabled.

11. The method of claim 8 wherein the step of selectively enabling or disabling further comprises:
disabling an interaction with a viewport on the second remote unit when the glass module is enabled; and
enabling a display associated with the second remote unit.

12. The method of claim 8 further comprising:
periodically and asynchronously calculating with the first process a current uniform resource locator (URL) associated with a viewport on the first remote unit; and
reporting the calculated current URL.

13. The method of claim 8 further comprising sending a command by the first process to enable or disable the glass module on the second remote unit.

14. The method of claim 8 further comprising:
storing a textual notation with a notepad module associated with the first process; and
transmitting the textual notation to the datastore.

15. A computer readable medium having stored thereon one or more sequences of instructions for causing one or more microprocessors to perform the steps for coordinated distance training, the steps comprising:
executing a first process on a first remote unit;
storing data from the first process in a datastore via a communicative coupling between the first remote unit and the datastore;
reading data from the datastore and providing the data to the first process via the communicative coupling;
executing a second process on a second remote unit, the second process including a glass module;
requesting data by the second process from the first process; and
selectively enabling or disabling the glass module in the second remote unit based on the requested data.

16. The computer readable medium of claim 15 wherein the step of selectively enabling or disabling further comprises instructions for:
disabling an interaction with a viewport on the second remote unit when the glass module is enabled; and
enabling an interaction with a viewport on the second remote unit when the glass module is disabled.

17. The computer readable medium of claim 15 wherein the step of selectively enabling or disabling further comprises instructions for:
disabling an interaction with a viewport on the second remote unit when the glass module is enabled; and
enabling a display associated with the second remote unit.

18. The computer readable medium of claim 15 further comprising instructions for:
periodically and asynchronously calculating with the first process a current uniform resource locator (URL) associated with a viewport on the first remote unit; and
reporting the calculated current URL.

19. The computer readable medium of claim 15 further comprising instructions for the first process to send a command which enables or disables the glass module on the second remote unit.

20. The computer readable medium of claim 15 further comprising instructions for:
storing a textual notation with a notepad module associated with the first process; and
transmitting the textual notation to the datastore.
